(19) United States
(12) Patent Application Publication
(10) Pub. No.: US 2005/0020706 A1
(43) Pub. Date: Jan. 27, 2005

(54) Method for producing polyurethane prepolymer having a low content of monomers

(76) Inventors: Guido Kollbach, Straelen (DE); Gerd Bolte, Monheim (DE); Nina Hassel, Kerken (DE); Heike Ulrike Hupfer-Bolte, Monheim (DE)

Correspondence Address: WOODCOCK WASHBURN LLP, ONE LIBERTY PLACE, 46TH FLOOR, PHILADELPHIA, PA, 19103, US

(21) Appl. No.: 10/871,343

(22) Filed: Jun. 18, 2004

Related U.S. Application Data
(63) Continuation of application No. PCT/EP02/14399, filed on Jun. 17, 2002.

(30) Foreign Application Priority Data
Dec. 18, 2001 (DE) 101 62 144.2

(51) Int. Cl. C08G 18/10; C08G 18/30; C08G 18/00

(52) U.S. Cl. 521/159; 528/59; 528/60

(57) ABSTRACT

This invention describes a process for the production of isocyanate-terminated polyurethane prepolymers by reacting polyisocyanates in stages with polyols and to their use.

This invention relates to a process for the production of isocyanate-terminated polyurethane prepolymers by reacting polyisocyanates in stages with polyols and to their use.

Laminating and coating adhesives based on polyurethane (PU) prepolymers which contain reactive terminal groups (reactive adhesives) are frequently used in practice for the production of composite materials, particularly multilayer films. The terminal groups are, in particular, terminal groups which are capable of reacting with water or other compounds which contain an acidic hydrogen atom. This form of reactivity enables the reactive PU prepolymers to be brought in the required form to the required place in the processable state (generally liquid to highly viscous) and to cure by the addition of water or other compounds containing an acidic hydrogen atom (known in this case as hardeners).

With these so-called two-component systems, the hardener is generally added immediately before application, only a limited processing time being available to the processor after addition of the hardener.

However, polyurethanes containing reactive terminal groups can also be cured without the addition of hardeners, i.e. solely by reaction with atmospheric moisture (one-component systems). One-component systems generally have the advantage over two-component systems that the user is spared the often laborious mixing of the frequently viscous components before application.

The polyurethanes terminated by reactive groups which are normally used in one-component or two-component systems include, for example, the polyurethanes containing preferably terminal isocyanate (NCO) groups.

In order to obtain NCO-terminated PU prepolymers, it is common practice to react polyhydric alcohols with an excess of monomeric polyisocyanates—generally at least predominantly diisocyanates.

It is known that, irrespective of the reaction time, a certain quantity of the polyisocyanate used in excess is left over after the reaction. The presence of monomeric polyisocyanate is problematical, for example, when readily volatile diisocyanates have been used as the monomeric polyisocyanate. Adhesives/sealants and, in particular, PU-based hotmelt adhesives are applied at elevated temperature. Thus, the application temperatures of hotmelt adhesives are in the range from 100° C. to 200° C. while those of laminating adhesives are in the range from room temperature to 150° C. Even at room temperature, volatile diisocyanates, such as IPDI or TDI, have a significant vapor pressure. This significant vapor pressure is serious above all in the case of spray application because, in this case, significant quantities of isocyanate vapors or aerosols can occur over the application unit. Isocyanate vapors are toxic in view of their irritating and sensitizing effect. The use of products with a high content of readily volatile diisocyanates involves elaborate measures on the part of the user to protect the people responsible for applying the product, more particularly elaborate measures for keeping the surrounding air fit to inhale, as legally stipulated by the maximum permitted concentration of working materials as gas, vapor or particulate matter in the air at the workplace (annually updated “MAK-Wert-Liste der Technischen Regel TRGS 900 des Bundesministeriums für Arbeit und Soziales”).

Since protective and cleaning measures generally involve considerable financial investment or costs, there is a need on the part of the user for products which—depending on the isocyanate used—have a low content of readily volatile diisocyanates.

“Readily volatile” substances in the context of the present specification are substances which have a vapor pressure of more than about 0.0007 mm Hg at 30° C. or a boiling point of less than about 190° C. (70 mPa).

If low-volatility diisocyanates, more particularly the widely used bicyclic diisocyanates, for example diphenylmethane diisocyanates, are used instead of the high-volatility diisocyanates, the PU prepolymers or adhesives based thereon generally obtained have viscosities that are normally outside the range relevant to simple methods of application. This also or additionally happens where it is intended to reduce the monomer content by reducing the NCO:OH ratio. In these cases, the viscosity of the polyurethane prepolymers can be reduced by addition of suitable solvents.

Another way of reducing viscosity is to add an excess of mono- or polyfunctional monomers, for example monomeric polyisocyanates, as so-called reactive diluents. These reactive diluents are incorporated in the coating or bond in the course of a subsequent hardening process (after addition of a hardener or by hardening under the effect of moisture).

Although the viscosity of the polyurethane prepolymer can actually be reduced in this way, the generally incomplete reaction of the reactive diluent and, in principle, the general presence of monomeric unreacted starting polyisocyanate often lead to the presence in the bond of free monomeric polyisocyanates which are capable of “migrating”, for example, within the coating or bond or, in some cases, even into the coated or bonded materials. Such migrating constituents are frequently known among experts as “migrates”. By contact with moisture, the isocyanate groups of the migrates are continuously reacted to amino groups. The content of the amines, particularly primary aromatic amines, thus formed must be below the detection limit—based on aniline hydrochloride—of 0.2 micrograms aniline hydrochloride/100 ml sample (Bundesinstitut für gesundheitlichen Verbraucherschutz und Veterinärmedizin, BGVV, nach amtlicher Sammiung von Untersuchungsverfahren nach § 35 LMBG—Untersuchung von Lebensmitteln/Bestimmung von primären aromatischen Aminen in wäissrigen Prüflebensmitteln).

Migrates are undesirable in the packaging industry and particularly in the packaging of foods. On the one hand, the passage of the migrates through the packaging material can lead to contamination of the packaged product; on the other hand, long waiting times are necessary before the packaging material is “migrate-free” and can be used.

Another unwanted effect which can be caused by the migration of monomeric polyisocyanates is the so-called antisealing effect in the production of bags or carrier bags from laminated plastic film. The laminated plastic films often contain a lubricant based on fatty acid amides. By reaction of migrated monomeric polyisocyanate with the fatty acid amide and/or moisture, urea compounds with a melting point above the sealing temperature of the plastic films are formed on the surface of the film. This leads to the formation between the films to be sealed of a “foreign” antisealing layer which counteracts the formation of a homogeneous sealing seam.

However, problems are caused not only by the use, but also the by the marketing of reactive adhesives containing monomeric polyisocyanate. Thus, substances and preparations containing, for example, more than 0.1% free MDI or TDI come under the law on hazardous materials and have to be identified accordingly. The obligation to do so involves special measures for packaging and transportation.

Accordingly, reactive adhesives suitable for the production of composite materials are supposed to have a suitable application viscosity, but not to contain or release any volatile or migratable substances into the environment. In addition, reactive adhesives of the type in question are expected to meet the requirement that, immediately after application to at least one of the materials to be joined, they have an initial adhesion after the materials have been joined which is sufficient to prevent the composite material from separating into its original constituents or to stop the bonded materials from shifting relative to one another. However, a corresponding bond is also expected to be sufficiently flexible to withstand the various tensile and elastic stresses to which the multilayer material still at the processing stage is generally exposed without any damage to the adhesive bond or to the bonded material.

Low-monomer polyurethanes containing NCO groups are described in WO 98/29466. They are obtained by
reacting the diisocyanate containing differently reactive NCO groups (nonsymmetrical diisocyanate) with polyhydric alcohols in an OH—NCO ratio of 4 to 0.55:1 in a first reaction step and, after virtually all fast NCO groups have reacted off with some of the OH groups present,
adding a more reactive diisocyanate (symmetrical diisocyanate) compared with the barely reactive NCO group of the isocyanate from reaction step 1 in less than the equivalent quantity, based on free OH groups, in a second reaction step optionally carried out in the presence of typical catalysts and/or at elevated temperatures.

WO 01/40342 describes reactive polyurethane sealant/adhesive compositions based on reaction products of polyols and high molecular weight diisocyanates. In a first step, a diol component is reacted with a stoichiometric excess of monomeric diisocyanate to form a high molecular weight diisocyanate and the resulting high molecular weight diisocyanate is precipitated from the reaction mixture, for example by addition of a non-solvent for the high molecular weight diisocyanate. In a second step, the high molecular weight diisocyanate is reacted with a polyol to form an isocyanate-terminated reactive prepolymer.

DE 130908 A1 relates to pressure-sensitive adhesive PU compositions produced by reaction of an NCO-containing PU prepolymer (A) with a corresponding OH-containing hardener (B). Component (A) is prepared by a two-stage reaction. In the first stage, an at least difunctional isocyanate is reacted with at least a first polyol component in an NCO:OH ratio of <2. Free OH groups are still present. In the second stage, another at least difunctional isocyanate is added and reacted with the prepolymer from the first stage, the other at least difunctional isocyanate having a higher reactivity than the majority of the NCO groups of the prepolymer from stage 1.

DE 4136490 relates to solventless coating systems and adhesive systems of polyols and isocyanate prepolymers which have low migration values shortly after their production. The NCO prepolymers are prepared from polyol mixtures with an average functionality of 2.05 to 2.5, which contain at least 90 mol-% secondary hydroxyl groups, and diisocyanates containing differently reactive isocyanate groups in a ratio of the NCO groups to OH groups of 1.6:1 to 1.8:1. Residual monomer contents of, for example, 0.03% TDI (Example C) and 0.4% 2,4′-MDI (Example B) are found in the prepolymer.

U.S. Pat. No. 5,925,781 describes a prepolymer with an NCO content of 2 to 16%, a viscosity of ca. 10,000 mPas at room temperature and a TDI monomer content of preferably below 0.3%. It is prepared from 2,4-TDI and at least one polyether polyol with an average molecular weight of 3,000 to 8,000 in an NCO—OH ratio of 1.3:1 to 2.3:1 and further reaction with a liquid diisocyanate of the diphenylmethane series and subsequent reaction with an alcohol or polyol.

DE 2438948 describes polyurethane prepolymers obtainable by reaction of arylene diisocyanate with a polyoxypropylene triol in an NCO:OH equivalent ratio of 1.6:0.1 to 2.25:0.6 in a first reaction stage and reaction with a polyoxypropylene diol and residual arylene diisocyanate in a second stage, by which an NCO:OH ratio of 2.0:1.0 is adjusted, and subsequent addition of aliphatic diisocyanate.

The acceleration of reactions between isocyanates and polyols by addition of catalysts, for example Lewis acids or Lewis bases, is also known. WO 98/02303 describes a process for the accelerated curing of laminates in which an ink together with a catalyst is applied almost completely to a first film, after which the first film is laminated onto a second film with the aid of an adhesive, the curing of the adhesive being accelerated by the catalyst.

Despite the prior art discussed in the foregoing, there is still a need for solventless or solvent-containing, low-monomer polyurethanes containing NCO groups either because the viscosities are still too high for some applications or because partly complicated and expensive purification steps have to be carried out to obtain the low level of monomeric polyisocyanates. Actual examples include the removal of excess monomeric polyisocyanates by selective extraction, for example with supercritical carbon dioxide, thin-layer distillation, thin-film evaporation or the precipitation of the NCO-containing polyurethane from the reaction mixture. In addition, long reaction times are often required to produce the low-monomer NCO-terminated polyurethane prepolymer.

Accordingly, the problem addressed by the present invention was to provide solventless or solvent-containing, NCO-terminated, low-viscosity polyurethane prepolymers which could be produced in shortened reaction times and which would have a low content of monomeric polyisocyanates without any need for complicated purification steps.

The solution to the problem stated above is defined in the claims and consists essentially in a process for the production of isocyanate-terminated polyurethane prepolymers, in which polyisocyanates are reacted with polyols,
(I) the polyisocyanate used in a first synthesis stage being
   a) at least one nonsymmetrical diisocyanate,
   b) the polyol being at least one polyol with an average molecular weight (Mₙ) of 60 to 3,000 g/mol,
   c) the ratio of isocyanate groups to hydroxyl groups being in the range from 1.2:1 to 4:1,
   d) a catalyst being added and, after the reaction,
(II) in a second synthesis stage,
   a) at least one other polyol being added so that the overall ratio of isocyanate groups to hydroxyl groups is in the range from 1.1:1 to 2:1.

The molecular weights mentioned hereinafter in regard to polymeric compounds represent the number average molecular weight (Mₙ), unless otherwise stated. All molecular weights mentioned are values obtainable by gel permeation chromatography (GPC), unless otherwise stated.

The polyisocyanates are compounds with the general structure O═C═N—X—N═C═O where X is an aliphatic, alicyclic or aromatic radical, preferably an aliphatic or alicyclic radical containing 4 to 18 carbon atoms.

Examples of suitable isocyanates are 1,5-naphthylene diisocyanate, 2,4- or 4,4′-diphenylmethane diisocyanate (MDI), hydrogenated MDI (H₁₂MDI), xylylene diisocyanate (XDI), tetramethyl xylylene diisocyanate (TMXDI), 4,4′-diphenyl dimethyl-methane diisocyanate, di- and tetraalkylene diphenylmethane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diiso-cyanato-2,2,4-trimethyl hexane, 1,6-diisocyanato-2,4,4-trimethyl hexane, 1-isocyanatomethyl-3-isocyanato-1,5,5-trimethyl cyclohexane (IPDI), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexylmethane diisocyanate, cyclo-hexane-1,4-diisocyanate, ethylene diisocyanate, phthalic acid-bis-isocyanatoethyl ester; diisocyanates containing reactive halogen atoms, such as 1-chloromethylphenyl-2,4-diisocyanate, 1-bromomethylphenyl-2,6-diisocyanate or 3,3-bis-chloromethylether4,4′-diphenyl diisocyanate.

From the group of aromatic polyisocyanates, methylene triphenyl triisocyanate (MIT), for example, is used. Aromatic diisocyanates are characterized by the fact that the isocyanate group is positioned directly on the benzene ring. Particularly suitable aromatic diisocyanates include 2,4- or 4,4′-diphenyl methane diisocyanate (MDI), the isomers of toluene diisocyanate (TDI), naphthalene-1,5-diisocyanate (NDI).

Sulfur-containing polyisocyanates are obtained, for example, by reaction of 2 mol hexamethylene diisocyanate with 1 mol thiodiglycol or dihydroxydihexyl sulfide. Other suitable diisocyanates are, for example, trimethyl hexamethylene diisocyanate, 1,4-diisocyanatobutane, 1,12-diisocyanatododecane and dimer fatty acid diisocyanate. Particularly suitable diisocyanates are tetramethylene, hexamethylene, undecane, dodecamethylene, 2,2,4-trimethylhexane-2,3,3-trimethylhexamethylene, 1,3-cyclohexane, 1,4-cyclohexane, 1,3- and 1,4-tetramethyl xylene, isophorone, 4,4-dicyclohexylmethane, tetramethylxylylene (TMXDI) and lysine ester diisocyanate.

Suitable at least trifunctional isocyanates are polyisocyanates formed by trimerization or oligomerization of diisocyanates or by reaction of diisocyanates with polyfunctional compounds containing hydroxyl or amino groups.

Isocyanates suitable for the production of trimers are the diisocyanates mentioned above, the trimerization products of HDI, MDI, TDI or IPDI being particularly preferred.

Blocked, reversibly capped polykisisocyanates, such as 1,3,5-tris-[6-(1-methylpropylideneaminoxycarbonylamino)-hexyl]-2,4,6-trixohexahydro-1,3,5-triazine, are also suitable.

The polymeric isocyanates formed, for example, as residue in the distillation of diisocyanates are also suitable for use. The polymeric MDI obtainable from the distillation residue in the distillation of MDI is particularly suitable.

A preferred embodiment of the invention is characterized by the use of, for example, Desmodur N 3300, Desmodur N 100 or the IPDI-trimeric isocyanaurate T 1890 (manufacturer: Bayer AG)

In selecting the polyisocyanates, it is important to bear in mind the fact that the NCO groups of the polyisocyanates can differ in their reactivity to compounds containing isocyanate-reactive functional groups. This applies in particular to diisocyanates containing NCO groups in different chemical environments, i.e. to nonsymmetrical diisocyanates. It is known that dicyclic diisocyanates or generally symmetrical diisocyanates have higher reaction rates than the second isocyanate group of nonsymmetrical or monocyclic diisocyanates.

In the context of the present invention, the term “polyol” encompasses a single polyol or a mixture of two or more polyols which may be used for the production of polyurethanes. A polyol is understood to be a polyhydric alcohol, i.e. a compound containing more than one OH group in the molecule.

Suitable polyols are, for example, aliphatic alcohols containing 2 to 4 OH groups per molecule. The OH groups may be both primary and secondary. Suitable aliphatic alcohols include, for example, ethylene glycol, propylene glycol, butane-1,4-diol, pentane-1,5-diol, hexane-1,6-diol, heptane-1,7-diol, octane-1,8-diol and higher homologs or isomers thereof which the expert can obtain by extending the hydrocarbon chain by one CH₂ group at a time or by introducing branches into the carbon chain. Also suitable are higher alcohols such as, for example, glycerol, trimethylol propane, pentaerythritol and oligomeric ethers of the substances mentioned either individually or in the form of mixtures of two or more of the ethers mentioned with one another.

Other suitable polyol components are the reaction products of low molecular weight polyhydric alcohols with alkylene oxides, so-called polyethers. The alkylene oxides preferably contain 2 to 4 carbon atoms. Suitable reaction products of the type in question are, for example, the reaction products of ethylene glycol, propylene glycol, the isomeric butane diols, hexane diols or 4,4′-dihydroxydiphenyl propane with ethylene oxide, propylene oxide or butylene oxide or mixtures of two or more thereof. The reaction products of polyhydric alcohols, such as glycerol, trimethylol ethane or trimethylol propane, pentaerythritol or sugar alcohols or mixtures of two or more thereof, with the alkylene oxides mentioned to form polyether polyols are also suitable.

Thus, depending on the desired molecular weight, products of the addition of only a few mol ethylene oxide and/or propylene oxide per mol or of more than one hundred mol ethylene oxide and/or propylene oxide onto low molecular weight polyhydric alcohols may be used. Other polyether polyols are obtainable by condensation of, for example, glycerol or pentaerythritol with elimination of water.

In addition, polyols widely used in polyurethane chemistry are obtainable by polymerization of tetrahydrofuran. Among the polyether polyols mentioned, products of the reaction of polyhydric low molecular weight alcohols with propylene oxide under conditions where at least partly secondary hydroxyl groups are formed are particularly suitable, especially for the first synthesis stage.

The polyethers are reacted in known manner by reacting the starting compound containing a reactive hydrogen atom with alkylene oxides, for example ethylene oxide, propylene oxide, butylene oxide, styrene oxide, tetrahydrofuran or epichlorohydrin or mixtures of two or more thereof.

Suitable starting compounds are, for example, water, ethylene glycol, 1,2- or 1,3-propylene glycol, 1,4- or 1,3-butylene glycol, hexane-1,6-diol, octane-1,8-diol, neopentyl glycol, 1,4-hydroxymethyl cyclohexane, 2-methyl propane-1,3-diol, glycerol, trimethylol propane, hexane-1,2,6-triol, butane-1,2,4-triol, trimethylol ethane, pentaerythritol, mannitol, sorbitol, methyl glycosides, sugars, phenol, isononylphenol, resorcinol, hydroquinone, 1,2,2- or 1,1,2-tris-(hydroxyphenyl)-ethane, ammonia, methyl amine, ethylenediamine, tetra- or hexamethylenediamine, triethanolamine, aniline, phenylenediamine, 2,4- and 2,6-diaminotoluene and polyphenylpolymethylene polyamines, which may be obtained by aniline/formaldehyde condensation, or mixtures of two or more thereof.

Polyethers modified by vinyl polymers are also suitable for use as a polyol component. Products such as these can be obtained, for example, by polymerizing styrene or acrylonitrile or mixtures thereof in the presence of polyethers.

Other suitable polyol components for the production of the isocyanate-terminated polyurethane prepolymer are polyester polyols. For example, it is possible to use polyester polyols obtained by reacting low molecular weight alcohols, more particularly ethylene glycol, diethylene glycol, neopentyl glycol, hexanediol, butanediol, propylene glycol, glycerol or trimethylol propane, with caprolactone. Other suitable polyhydric alcohols for the production of polyester polyols are 1,4-hydroxymethyl cyclohexane, 2-methyl propane-1,3-diol, butane-1,2,4-triol, triethylene glycol, tetraethylene glycol, polyethylene glycol, dipropylene glycol, polypropylene glycol, dibutylene glycol and polybutylene glycol.

Other suitable polyester polyols can be obtained by polycondensation. Thus, dihydric and/or trihydric alcohols may be condensed with less than the equivalent quantity of dicarboxylic acids and/or tricarboxylic acids or reactive derivatives thereof to form polyester polyols. Suitable dicarboxylic acids are, for example, adipic acid or succinic acid and higher homologs thereof containing up to 16 carbon atoms, unsaturated dicarboxylic acids, such as maleic acid or fumaric acid, and aromatic dicarboxylic acids, more particularly the isomeric phthalic acids, such as phthalic acid, isophthalic acid or terephthalic acid. Citric acid and trimellitic acid, for example, are also suitable tricarboxylic acids. The acids mentioned may be used individually or as mixtures of two or more thereof. Polyester polyols of at least one of the dicarboxylic acids mentioned and glycerol which have a residual content of OH groups are particularly suitable for the purposes of the present invention. Particularly suitable alcohols are hexanediol, ethylene glycol, diethylene glycol or neopentyl glycol or mixtures of two or more thereof. Particularly suitable acids are isophthalic acid and adipic acid and mixtures thereof. High molecular weight polyester polyols may be used in the second synthesis stage and include, for example, the reaction products of polyhydric, preferably dihydric, alcohols (optionally together with small quantities of trihydric alcohols) and polybasic, preferably dibasic, carboxylic acids. Instead of free polycarboxylic acids, the corresponding polycarboxylic anhydrides or corresponding polycarboxylic acid esters with alcohols preferably containing 1 to 3 carbon atoms may also be used (where possible). The polycarboxylic acids may be aliphatic, cycloaliphatic, aromatic or heterocyclic or both. They may optionally be substituted, for example by alkyl groups, alkenyl groups, ether groups or halogens. Suitable polycarboxylic acids are, for example, succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acid or trimer fatty acid or mixtures of two or more thereof. Small quantities of monofunctional fatty acids may optionally be present in the reaction mixture.

The polyesters may optionally contain a small number of terminal carboxyl groups. Polyesters obtainable from lactones, for example based on ε-caprolactone (also known as “polycaprolactones”), or hydroxycarboxylic acids, for example ω-hydroxycaproic acid, may also be used.

However, polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkyl ester polyols with 1 to 12 carbon atoms in the alkyl group. Other suitable polyols are polycarbonate polyols and dimer diols (Henkel KGaA) and also castor oil and derivatives thereof. The hydroxyfunctional polybutadienes known, for example, by the commercial name of “Poly-bd” may also be used as polyols for the compositions according to the invention.

Polyacetals are also suitable for use as the polyol component. Polyacetals are understood to be compounds obtainable by reacting glycols, for example diethylene glycol or hexanediol or mixtures thereof, with formaldehyde. Polyacetals suitable for the purposes of the invention may also be obtained by polymerizing cyclic acetals.

Polycarbonates are also suitable or use as the polyol component. Polycarbonates may be obtained, for example, by reacting diols, such as propylene glycol, butane-1,4-diol or hexane-1,6-diol, diethylene glycol, triethylene glycol or tetraethylene glycol or mixtures of two or more thereof, with diaryl carbonates, for example diphenyl carbonate, or phosgene.

Polyacrylates containing OH groups are also suitable for use as the polyol component. These polyacrylates may be obtained, for example, by polymerizing ethylenically unsaturated monomers bearing an OH group. Such monomers are obtainable, for example, by esterification of ethylenically unsaturated carboxylic acids and dihydric alcohols, the alcohol generally being present in a slight excess. Ethylenically unsaturated carboxylic acids suitable for this purpose are, for example, acrylic acid, methacrylic acid, crotonic acid or maleic acid. Corresponding OH-functional esters are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

In the first synthesis stage, at least one nonsymmetrical diisocyanate is used as the polyisocyanate. The nonsymmetrical diisocyanate is selected from the group of aromatic, aliphatic or cycloaliphatic diisocyanates.

Examples of suitable aromatic diisocyanates containing differently reactive NCO groups are all isomers of toluene diisocyanate (TDI) either in the form of the pure isomer or as a mixture of several isomers, napthalene-1,5-diisocyanate (NDI) and 1,3-phenylene diisocyanate.

Examples of aliphatic diisocyanates containing differently reactive NCO groups are 1,6-diisocyanato-2,2,4-trimethylhexane, 1,6-diisocyanato-2,4,4-trimethylhexane and lysine diisocyanate.

Examples of suitable cycloaliphatic diisocyanates containing differently reactive NCO groups are 1-isocyanatomethyl-3-isocyanato-1,5,5-trimethyl cyclohexane (isophorone diisocyanate, IPDI) and 1-methyl-2,4-diisocyanatocyclohexane.

At least one nonsymmetrical diisocyanate from the group comprising toluene diisocyanate (TDI) either in the form of the pure isomer or as a mixture of several isomers; 1-isocyanatomethyl-3-isocyanato-1,5,5-trimethyl diisocyanate (isophorone diisocyanate, IPDI); 2,4-diphenylmethane diisocyanate.

The polyol used in the first synthesis stage is at least one polyol with an average molecular weight (Mₙ) of 60 to 3000 g/mol, preferably 100 to 2000 g/mol and more particularly 200 to 1200 g/mol.

At least one polyether polyol with a molecular weight (Mₙ) of 100 to 3000 g/mol and preferably in the range from 150 to 2000 g/mol and/or at least one polyester polyol with a molecular weight of 100 to 3000 g/mol and preferably in the range from 250 to 2500 g/mol is/are preferably used in the first synthesis stage.

In a preferred embodiment, at least one polyol containing differently reactive hydroxyl groups is used in the first synthesis stage. A difference in reactivity is present, for example, between primary and secondary hydroxyl groups.

Actual examples of the polyols to be used in accordance with the invention are propane-1,2-diol, butane-1,2-diol, dipropylene glycol, tripropylene glycol, tetrapropylene glycol, the higher homologs of polypropylene glycol with an average molecular weight (number average Mn) of up to 3000, more particularly up to 2500 g/mol, and copolymers of polypropylene glycol, for example block or statistical copolymers of ethylene and propylene oxide.

In the first synthesis stage, the ratio of isocyanate groups to hydroxyl groups is adjusted to a value of 1.2:1 to 4:1, preferably to a value of 1.5:1 to 3:1 and more particularly to a value of 1.8:1 to 2.5:1.

The reaction between the at least one nonsymmetrical diisocyanate and the at least one polyol with an average molecular weight (Mₙ) of 60 to 3,000 g/mol takes place at a temperature of 20° C. to 80° C. and preferably at a temperature of 40 to 75° C. In one particular embodiment, the reaction of the first synthesis stage takes place at room temperature.

In another particular embodiment of the invention, the reaction of the first synthesis stage is carried out in aprotic solvents. The percentage by weight of the reaction mixture in the mixture containing the aprotic solvent is in the range from 20 to 80% by weight, preferably in the range from 30 to 60% by weight and more particularly in the range from 35 to 50% by weight.

The reaction in the aprotic solvents takes place at temperatures in the range from 20° C. to 100° C. preferably at temperatures in the range from 25° C. to 80° C. and more particularly at temperatures in the range from 40° C. to 75° C. Aprotic solvents in the context of the invention are, for example, halogen-containing organic solvents although acetone, methylisobutyl ketone or ethyl acetate is preferred.

The reaction mixture of the first synthesis stage contains a catalyst. Catalysts suitable for use in accordance with the invention are organometallic compounds and/or tertiary amines in concentrations of 0.1 to 5% by weight, preferably in concentrations of 0.3 to 2% by weight and more particularly in concentrations of 0.5 to 1% by weight. Organometallic compounds of tin, iron, titanium, bismuth or zirconium are preferred. Preferred above all are such organometallic compounds as tin(II) salts or titanium(IV) salts of carboxylic acids, strong bases, such as alkali metal hydroxides, alcohols and phenolates, for example di-n-octyl tin mercaptide, dibutyl tin maleate, diacetate, dilaurate, dichloride, bis-dodecyl mercaptide, tin(II) acetate, ethylhexoate and diethylhexoate, tetraisopropyl titanate or lead phenyl ethyl dithiocarbamate. Another class of compounds are the dialkyl tin(IV) carboxylates. The carboxylic acids contain 2, preferably at least 10 and more particularly 14 to 32 carbon atoms. Dicarboxylic acids may also be used. Acids which may be expressly mentioned include adipic acid, maleic acid, fumaric acid, malonic acid, succinic acid, pimelic acid, terephthalic acid, phenylacetic acid, benzoic acid, acetic acid, propionic acid and 2-ethylhexanoic acid, caprylic acid, capric acid, lauric acid, myristic acid, palmitic acid and stearic acid. Actual compounds are dibutyl and dioctyl tin diacetate, maleate, bis-(2-ethylhexoate), dilaurate, tributyl tin diacetate, bis-(β-methoxycarbonylethyl)-tin dilaurate and bis-(β-acetylethyl)-tin dilaurate.

Tin oxides and sulfides and tin thiolates may also be used. Actual examples include bis-(tributyltin)-oxide, bis-(trioctyltin)-oxide, dibutyl and dioctyl tin bis-(2-ethylhexylthiolate), dibutyl and dioctyl tin didodecyl thiolate, bis-(β-methoxycarbonylethyl)-tin didodecyl thiolate, bis-(β-acetylethyl)-tin bis-(2-ethylhexylthiolate), dibutyl and dioctyl tin didodecyl thiolate, butyl and octyltin tris-(thioglycolic acid-2-ethylhexoate), dibutyl and dioctyl tin bis-(thioglycolic acid-2-ethylhexoate), tributyl and trioctyl tin bis-(thioglycolic acid-2-ethylhexoate) and butyl and octyl tin tris-(thioethyleneglycol-2-ethylhexoate), dibutyl and dioctyl tin bis-(thioethyleneglycol-2-ethylhexoate), tributyl and trioctyl tin bis-(thioethyleneglycol-2-ethylhexoate) with the general formula Rₙ₊₁Sn(SCH₂CH₂OCOC₈H₁₇)₃₋ₙ, where R is a C₄₋₈ alkyl group, bis-(β-methoxycarbonylethyl)-tin bis-(thioethyleneglycol-2-ethylhexoate), bis-(β-methoxycarbonylethyl)-tin bis-(thioglycolic acid-2-ethylhexoate) and bis-(β-acetylethyl)-tin bis-(thioethyleneglycol-2-ethylhexoate) and bis-(β-acetylethyl)-tin bis-(thioglycolic acid-2-ethylhexoate).

Organobismuth compounds, for example triaryl bismuth compounds, oxides of these compounds and alkyl or aryl halobismuthines of the R₂BiX and R₃BiX₂ type and phenolates and carboxylates of bismuth, may also be used. Suitable organobismuth compounds are, in particular, bismuth carboxylates, the carboxylic acids containing 2 to 20 carbon atoms and preferably 4 to 14 carbon atoms. Acids which may be expressly mentioned include butyric acid, caproic acid, caprylic acid, capric acid, lauric acid, myristic acid, palmitic acid, stearic acid, arachic acid, isobutyric acid and 2-ethylhexanoic acid. Mixtures of bismuth carboxylates with other metal carboxylates, for example tin carboxylates, may also be used.

More particularly, the following tertiary amines are used as catalyst either individually or in combination with at least one of the above-mentioned catalysts: diazabicyclooctane (Dabco), triethylamine, dimethyl benzylamine (Desmorapid DB, BAYER AG), bis-dimethylaminoethyl ether (Catalyst A I, UCC), tetramethyl guanidine, bis-dimethylaminomethyl phenol, 2,2′-dimorpholinodiethyl ether, 2-(2-dimethylaminoethoxy)-ethanol, 2-dimethylaminoethyl-3-dimethylaminopropyl ether, bis-(2-diaminoethyl)-ether, N,N-dimethyl piperazine, N-(2-hydroxyethoxyethyl)-2-azanorbornane, Tacat DP-914 (Texaco Chemical), Jeffcat®, N,N,N,N-tetramethyl butane-1,3-diamine, N,N,N,N-tetramethyl propane-1,3-diamine or N,N,N,N-tetramethyl hexane-1,6-diamine and, for example, triethanolamine or triisopropanolamine.

The catalysts may also be present in oligomerized or polymerized form, for example as N-methylated polyethylene imine.

Other suitable catalysts are 1-methyl imidazole, 2-methyl-1-vinyl imidazole, 1-allyl imidazole, 1-phenyl imidazole, 1,2,4,5-tetramethyl imidazole, 1-(3-aminopropyl)-imidazole, pyrimidazole, 4-dimethyl aminopyridine, 4-pyrrolidinopyridine, 4-morpholinopyridine, 4-methyl pyridine and N-dodecyl-2-methyl imidazole.

Combinations of organometallic compounds and amines are particularly preferred for the purposes of the invention, the ratio of amine to organometallic compound being 0.5:1 to 10:1, preferably 1:1 to 5:1 and more particularly 1.5:1 to 3:1.

In one particularly preferred embodiment of the invention, ε-caprolactam is used as the catalyst. The quantity of ε-caprolactam used is in the range from 0.05 to 6% by weight, preferably in the range from 0.1 to 3% by weight and more particularly in the range from 0.2 to 0.8% by weight, based on the total quantity of nonsymmetrical diisocyanate and polyol used in the first synthesis stage. The ε-caprolactam may be used in powder, granular or liquid form.

The reaction product from the first synthesis stage preferably has an NCO value of 3 to 22% by weight and, more particularly, in the range from 3.5 to 11.5% by weight (to Spiegelberger, EN ISO 11909).

In a second synthesis stage, at least one other polyol is added so that the overall ratio of isocyanate groups to hydroxyl groups is 1.1:1 to 2:1, preferably 1.3:1 to 1.8:1 and more particularly 1.45:1 to 1.75:1.

In the second synthesis stage, the at least one other polyol is added at a temperature of 20° C. to 100° C. and preferably at a temperature of 25° C. to 90° C.

It is preferably a polyether or polyether mixture with a molecular weight (Mₙ) of ca. 100 to 10000 g/mol and preferably in the range from ca. 200 to ca. 5000 g/mol or a polyester polyol or polyester polyol mixture with a molecular weight (Mₙ) of ca. 200 to 10000 g/mol.

In one particular embodiment, at least one polyether polyol and/or at least one polyester polyol with a molecular weight (Mₙ) of 100 to 3,000 g/mol is/are used in the first synthesis stage and at least one polyether polyol with a molecular weight (Mₙ) of 100 to about 10,000 g/mol and/or at least one polyester polyol with a molecular weight (Mₙ) of 200 to 10,000 g/mol is/are used in the second synthesis stage.

In another particular embodiment, the second synthesis stage is also carried out in at least one of the above-mentioned aprotic solvents. The percentage by weight of the reaction mixture as a whole in the mixture containing the aprotic solvent is from 30 to 60% by weight and preferably from 35 to 50% by weight. If solventless polyurethanes are required, the solvent is distilled off after the end of the reaction and after stirring for 30 to 90 minutes.

Besides the polyols mentioned thus far, other compounds containing functional groups reactive to isocyanates—for example amines but also water—may also be used for the production of the polyurethane prepolymer. The following compounds are also mentioned:
succinic acid di-2-hydroxyethylamide, succinic acid di-N-methyl-(2-hydroxyethyl)-amide, 1,4-di-(2-hydroxymethylmercapto)-2,3,5,6-tetrachlorobenzene, 2-methylene-1,3-propanediol, 2-methyl-1,3-propanediol, 3-pyrrolidino-1,2-propanediol, 2-methylene-2,4-pentanediol, 3-alkoxy-1,2-propanediol, 2-ethylhexane-1,3-diol, 2,2-dimethyl-1,3-propanediol, 1,5-pentanediol, 2,5-dimethyl-2,5-hexanediol, 3-phenoxy-1,2-propanediol, 3-benzyloxy-1,2-propanediol, 2,3-dimethyl-2,3-butanediol, 3-(4-methoxyphenoxy)-1,2-propanediol and hydroxymethyl benzyl alcohol;
aliphatic, cycloaliphatic and aromatic diamines, such as ethylenediamine, hexamethylenediamine, 1,4-cyclohexylenediamine, piperazine, N-methyl propylenediamine, diaminodiphenyl sulfone, diaminodiphenyl ether, diaminodiphenyl dimethyl methane, 2,4-diamino-6-phenyl triazine, isophoronediamine, dimer fatty acid diamine, diaminodiphenyl methane, aminodiphenylamine or the isomers of phenylenediamine;
carbohydrazides or hydrazides of dicarboxylic acids;
aminoalcohols, such as ethanolamine, propanolamine, butanolamine, N-methyl ethanolamine, N-methyl isopropanolamine, diethanolamine, triethanolamine and higher di- or tri(alkanolamines);
aliphatic, cycloaliphatic, aromatic and heterocyclic mono- and diaminocarboxylic acids, such as glycine, 1- and 2-alanine, 6-aminocaproic acid, 4-aminobutyric acid, the isomeric mono- and diaminobenzoic acids and the isomeric mono- and diaminonaphthoic acids.

In addition, the isocyanate-terminated polyurethane prepolymer may optionally contain stabilizers, adhesion-promoting additives, such as tackifying resins, fillers, pigments, plasticizers and/or solvents as optional components.

“Stabilizers” in the context of the present invention are, on the one hand, stabilizers which stabilize the viscosity of the polyurethane according to the invention during production, storage and application. Stabilizers suitable for this purpose are, for example, monofunctional carboxylic acid chlorides, monofunctional highly reactive isocyanates and also non-corrosive inorganic acids, for example benzoyl chloride, toluenesulfonyl isocyanate, phosphoric acid or phosphorous acid. Other suitable stabilizers in the context of the invention are antioxidants, UV stabilizers and hydrolysis stabilizers. The choice of these stabilizers is determined on the one hand by the principal components of the polyurethane according to the invention and, on the other hand, by the application conditions and the stressing which the cured product can be expected to undergo. If the low-monomer polyurethane according to the invention consists predominantly of polyether units, antioxidants, optionally in combination with UV stabilizers, are mainly required. Examples of such stabilizers are the commercially available sterically hindered phenols and/or thioethers and/or substituted benzotriazoles or the sterically hindered amines of the HALS (hindered amine light stabilizer) type.

If the isocyanate-terminated polyurethane prepolymer consists largely of polyester units, hydrolysis stabilizers, for example of the carbodiimide type, may be used.

If the isocyanate-terminated polyurethane prepolymers produced by the process according to the invention are used in lamination adhesives, they may additionally contain tackifying resins, for example abietic acid, abietic acid esters, terpene resins, terpene/phenol resins or hydrocarbon resins, and also fillers (for example silicates, talcum, calcium carbonates, clays or carbon black), plasticizers (for example phthalates) or thixotropicizing agents (for example bentones, pyrogenic silicas, urea derivatives, fibrillated or pulped chopped strands) or dye pastes or pigments.

In addition, in this case, the polyurethane prepolymers produced by the process according to the invention may also be produced in solution and used as one-component or two-component laminating adhesives, preferably in polar aprotic solvents. The preferred solvents have a boiling range of ca. 50° C. to 140° C. Although halogenated hydrocarbons are also suitable, ethyl acetate, methyl ethyl ketone (MEK) and acetone are particularly preferred.

Besides the polyols, other diisocyanates, but preferably triisocyanates, may be used in the second reaction stage. This may be done in combination with the polyol or even by addition of the diisocyanate/triisocyanate on its own. Preferred triisocyanates are adducts of diisocyanates and low molecular weight triols, more especially the adducts of aromatic diisocyanates and triols, for example trimethylol propane or glycerol. Aliphatic triisocyanates such as, for example, the biuretization product of hexamethylene diisocyanate (HDI) or the isocyanuratization product of HDI or even the same trimerization products of isophorone diisocyanate (IPDI) are also suitable for the compositions according to the invention providing the percentage diisocyanate content is <1% by weight and the percentage content of isocyanates with a functionality of four or more is no greater than 25% by weight. The above-mentioned trimerization products of HDI and IPDI are particularly preferred by virtue of their ready availability. The polyisocyanate may be added at a temperature of 25° to 100° C.

The isocyanate-terminated polyurethane prepolymer produced by the process according to the invention is low in monomers. “Low in monomers” is understood to mean a low concentration of the starting polyisocyanates in the polyurethane prepolymer produced in accordance with the invention. The monomer concentration is below 1, preferably below 0.5, more preferably below 0.3 and most preferably below 0.1% by weight, based on the total weight of the solventless polyurethane prepolymer.

The percentage by weight of the monomeric nonsymmetrical diisocyanate is determined by gas chromatography, by high-pressure liquid chromatography (HPLC) or by gel permeation chromatography (GPC).

The polyurethane prepolymer produced by the process according to the invention has a Brookfield viscosity at 100° C., as measured to ISO 2555, in the range from 100 mPas to 15,000 mPas, preferably in the range from 150 mPas to 12,000 mPas and more particularly in the range from 200 to 10,000 mpas.

The NCO content of the polyurethane prepolymer produced in accordance with the invention is in the range from 1 to 10% by weight, preferably in the range from 2 to 8% by weight and more particularly in the range from 2.2 to 6% by weight (Spiegelberger, EN ISO 11909).

Accordingly, the polyurethane prepolymers produced in accordance with the invention are distinguished by an extremely low percentage content of monomeric readily volatile diisocyanates with a molecular weight below 500 g/mol which are unsafe from the factory hygiene perspective. The process has the economic advantage that the low monomer content is obtained without complicated and expensive process steps. In addition, the polyurethane prepolymers are free from the secondary products, such as crosslinking or depolymerization products, which are normally obtained in heat-based purification steps. Shorter reaction times are achieved by the process according to the invention, despite which the selectivity between the different reactive NCO groups of the nonsymmetrical diisocyanate is maintained to such an extent that polyurethane prepolymers with low viscosities are obtained.

The polyurethane prepolymers produced in accordance with the invention are preferably used either as such or in solution in organic solvents as an adhesive or adhesive component for bonding plastics, metals and papers. By virtue of their extremely low percentage content of migratable monomeric diisocyanates, the polyurethane prepolymers produced in accordance with the invention are particularly suitable for laminating textiles, aluminium foils and plastic films and metal- or oxide-coated (metallized) films and papers. Typical hardeners, for example polyfunctional relatively high molecular weight polyols (two-component systems), may be added or surfaces with defined moisture contents may be directly bonded using the products produced in accordance with the invention. Film laminates produced using the polyurethane prepolymers produced in accordance with the invention are characterized by a high processing safety level during heat sealing. This is attributable to the greatly reduced percentage content of migratable low molecular weight products in the polyurethane. In addition, the NCO-containing low-monomer polyurethane prepolymers produced in accordance with the invention may also be used in extrusion, printing and metallizing primers and for heat sealing. The polyurethanes produced in accordance with the invention are also suitable for the production of rigid, flexible and integral foams and in sealants.

The invention is illustrated by the following Examples.

### EXAMPLE 1

Quantity weighed out

| | | |
|---|---|---|
| 122.8 g | Polyether polyol | (OHV: 275) |
| 134.7 g | IPDI | (NCO: 37.8%) |
| 291.5 g | Polyester polyol | (OHV: 60) |
| 50.0 g | IPDI-based isocyanurate | (NCO: 17.2%) |
| 1.0 g | Catalyst (dibutyl tin dilaurate) | |
| 400.0 g | Ethyl acetate | |

Procedure:
Apparatus: Three-necked flask with contact thermometer, stirrer plus motor, reflux condenser with drying tube and heating mushroom
Method: The polyether polyol is initially introduced in ethyl acetate. After addition of the IPDI and the catalyst (dibutyl tin dilaurate), the mixture is heated and stirred under reflux conditions.
End point of the 1st stage: 3.9% by weight NCO in the polyurethane prepolymer.
The polyester polyol is then added. The reaction mixture is re-stirred under reflux conditions.
End point of the 2nd stage: 1.4% by weight NCO in the polyurethane prepolymer.
The total reaction time for the first and second stages of the production of the polyurethane prepolymer is 6 hours.
After the addition of the IPDI-based isocyanurate, the mixture is homogenized for 30 minutes. Finally, the mixture is cooled and placed in containers.
NCO value: 2.1% by weight
Viscosity (Brookfield LVT, spindle 2, 50 r.p.m., 20° C.): 261.6 mPas
IPDI monomer content: 0.03% by weight

### EXAMPLE 2

Quantity weighed out

| | | |
|---|---|---|
| 292.2 g | Polyester polyol | (OHV: 60) |
| 134.1 g | IPDI | (NCO: 37.8%) |
| 122.7 g | Polyether polyol | (OHV: 275) |
| 50.0 g | IPDI-based isocyanurate | (NCO: 17.2%) |
| 1.0 g | Catalyst (dibutyl tin dilaurate) | |
| 400.0 g | Ethyl acetate | |

Procedure:
Apparatus: Three-necked flask with contact thermometer, stirrer plus motor, reflux condenser with drying tube and heating mushroom
Method: The polyester polyol is initially introduced in ethyl acetate. After addition of the IPDI and the catalyst (dibutyl tin dilaurate), the mixture is heated and stirred under reflux conditions.
End point of the 1st stage: 4.6% by weight NCO in the polyurethane prepolymer.
The polyether polyol is then added. The reaction mixture is re-stirred under reflux conditions.
End point of the 2nd stage: 1.3% by weight NCO in the polyurethane prepolymer.
The total reaction time for the first and second stages of the production of the polyurethane prepolymer is 6 hours.
After the addition of the IPDI-based isocyanurate, the mixture is homogenized for 30 minutes. Finally, the mixture is cooled and placed in containers.
NCO value: 2.1% by weight
Viscosity (Brookfield LVT, spindle 2, 50 r.p.m., 20° C.): 281 mPas
IPDI monomer content: 0.12% by weight

### EXAMPLE 3

Quantity weighed out

| | | |
|---|---|---|
| 630.32 g | Polyether polyol 1 | (OHV: 108) |
| 207.60 g | TDI | (NCO: 48.2%) |
| 157.08 g | Polyether polyol 2 | (OHV: 53) |
| 5.00 g | Catalyst (ε-caprolactam) | |

Procedure:
Apparatus: Three-necked flask with contact thermometer, stirrer plus motor, drying tube and heating mushroom
Method:
Polyether polyol 1 is initially introduced and the catalyst (ε-caprolactam) is added. The TDI is then added. After the exothermic reaction has abated, the mixture is stirred at ca. 70-80° C. until the end point of the 1st stage is reached.
End point of the 1st stage: 5.8% by weight NCO in the polyurethane prepolymer. Polyether polyol 2 is then added. The reaction mixture is re-stirred at ca. 70-80° C.
End point of the 2nd stage: 4.0% by weight in the polyurethane prepolymer.
The total reaction time for the first and second stages of the production of the polyurethane prepolymer is 3 hours.
NCO value: 4.0% by weight
Viscosity (Brookfield RVT, spindle 27, 50 r.p.m., 40° C.):4000-6000 mPas
TDI monomer content: 0.03% by weight

### EXAMPLE 4

| Quantity weighed out | | |
|---|---|---|
| 631.38 g | Polyether polyol 1 | (OHV: 108) |
| 188.97 g | TDI | (NCO: 48.2%) |
| 176.65 g | Polyether polyol 2 | (OHV: 53) |
| 3.00 g | Catalyst (DABCO) | |

Procedure:
Apparatus: Three-necked flask with contact thermometer, stirrer plus motor, drying tube and heating mushroom
Method:
Polyether polyol 1 is initially introduced and the catalyst (DABCO) is added. The TDI is then added. After the exothermic reaction has abated, the mixture is stirred at ca. 70-80° C. until the end point of the 1st stage is reached.
End point of the 1st stage: 5.5% by weight NCO in the polyurethane prepolymer.
Polyether polyol 2 is then added. The reaction mixture is re-stirred at ca. 70-80° C.
End point of the 2nd stage: 3.9% by weight NCO in the polyurethane prepolymer.
The total reaction time for the first and second stages of the production of the polyurethane prepolymer is 3 hours.
NCO value: 3.5% by weight
Viscosity (Brookfield RVT, spindle 27, 50 r.p.m., 40° C.):28000-32000 mPas
TDI monomer content: 0.03% by weight

### EXAMPLE 5 (comparison)

| Quantity weighed out | | |
|---|---|---|
| 631.38 g | Polyether polyol 1 | (OHV: 108) |
| 188.97 g | TDI | (NCO: 48.2%) |
| 176.65 g | Polyether polyol 2 | (OHV: 53) |

Procedure:
Apparatus: Three-necked flask with contact thermometer, stirrer plus motor, drying tube and heating mushroom
Method:
Polyether polyol 1 is initially introduced. The TDI is then added. After the exothermic reaction has abated, the mixture is stirred at ca. 70-80° C. until the end point of the 1st stage is reached.
End point of the 1st stage: 7.1% by weight NCO in the polyurethane prepolymer.
Polyether polyol 2 is then added. The reaction mixture is re-stirred at ca. 70-80° C.
End point of the 2nd stage: 4.8% by weight NCO in the polyurethane prepolymer.
The total reaction time for the first and second stages of the production of the polyurethane prepolymer is 5 hours.
NCO value: 4.8% by weight
Viscosity (Brookfield RVT, spindle 27, 50 r.p.m., 40° C.):3250 mPas
TDI monomer content: 0.55% by weight

1. A process for the production of isocyanate-terminated polyurethane prepolymers, in which polyisocyanates are reacted with polyols,
(I) the polyisocyanate used in a first synthesis stage being
a) at least one nonsymmetrical diisocyanate,
b) the polyol being at least one polyol with an average molecular weight (Mₙ) of 60 to 3000 g/mol,
c) the ratio of isocyanate groups to hydroxyl groups being in the range from 1.5:1 to 3:1,
d) an organometallic compound or ε-caprolactam being added as catalyst and, after the reaction,
(II) in a second synthesis stage,
a) at least one other polyol being added so that the overall ratio of isocyanate groups to hydroxyl groups is in the range from 1.1:1 to 2:1.

2. A process as claimed in claim 1, characterized in that at least one nonsymmetrical diisocyanate from the group comprising toluene diisocyanate (TDI) either in the form of the pure isomer or as a mixture of several isomers; 1-isocyanatomethyl-3-isocyanato-1,5,5-trimethyl diisocyanate (isophorone diisocyanate, IPDI); 2,4-diphenylmethane diisocyanate is used in the first synthesis stage.

3. A process as claimed in claim 1, characterized in that at least one polyol with an average molecular weight (Mₙ) of 200 to 1200 g/mol is used in the first synthesis stage.

4. A process as claimed in claim 1, characterized in that at least one polyether polyol with a molecular weight (Mₙ) of 100 to 3000 g/mol and/or at least one polyester polyol with a molecular weight (Mₙ) of 100 to 3000 g/mol is/are used in the first synthesis stage.

5. A process as claimed in claim 1, characterized in that polyether polyols with a molecular weight of 100 to 10000 g/mol and/or polyester polyols with a molecular weight of 200 to 10000 g/mol are used in the second synthesis stage.

6. A process as claimed in claim 1, characterized in that the monomer concentration in the polyurethane prepolymer produced is below 0.3% by weight.

7. A process as claimed in claim 1, characterized in that the polyurethane prepolymer has a Brookfield viscosity at 100° C. (as measured to ISO 2555) in the range from 100 mPas to 15000 mPas.

8. The use of the isocyanate-terminated polyurethane prepolymer produced by the process claimed in any of claims 1 to 7 for the production of reactive one- or two-component adhesives/sealants.

9. The use claimed in claim 8 for the production of reactive hotmelt adhesives and solventless or solvent-containing laminating adhesives.

10. The use of the isocyanate-terminated polyurethane prepolymer produced by the process claimed in any of claims 1 to 7 for the production of assembly foams, potting compounds and rigid, flexible and integral foams.
